(19) United States
(12) Patent Application Publication
(10) Pub. No.: US 2012/0273482 A1
(43) Pub. Date: Nov. 1, 2012

(54) CERAMIC COOKING UTENSIL

(76) Inventor: Christophe Amprimo, Mehun sur Yevre (FR)

(21) Appl. No.: 13/508,396

(22) PCT Filed: Nov. 8, 2010
(86) PCT No.: PCT/FR10/00743

§ 371 Date: Jul. 17, 2012

(30) Foreign Application Priority Data
Nov. 6, 2009 (FR) 0957863
Jun. 10, 2010 (FR) 1054611

(51) Int. Cl. H05B 6/12

(52) U.S. Cl. 219/621; 156/230

(57) ABSTRACT

A cooking utensil made out of ceramics and optimized for the use on an induction plate. The cooking utensil comprises a ceramics container, an external base of the container, and a coating layer containing silver powder on the external base. The coating layer is deposited according to a geometrical form configured to optimize the magnetic properties of the silver powder by distributing in a homogeneous manner on the container a heating power output by the induction plate. The thickness of the coating layer is defined according to the maximum heating power to be reached by the base of the container.

### FIELD OF THE INVENTION

The present invention refers to a cooking utensil made out of ceramics. More particularly, the present invention refers to a ceramics container for induction heating. The field of the invention is that of the kitchen utensils made out of ceramics.

The object of the invention aims at providing a kitchen utensil made out of ceramics able to be heated by induction, and having an improved resistance to dilations and/or deformations, while maintaining a good continuity of the currents induced in the bottom.

### BACKGROUND OF THE INVENTION

Today, home induction plates are more and more gaining a foothold in the market of the cooking hobs. However, ceramics containers representing an important proportion of the kitchen utensils are not adapted to be used for induction heating.

In the state of the art, the document EP 0 695 282 is known which discloses a solution for using ceramics containers on induction plates. To this end, this document proposes to deposit on the bottom of a ceramics container by painting, serigraphy or transfer, a thin layer of material having electricity conducting properties and/or magnetic properties leading to the generation of heat by exposition to an electromagnetic field.

This document has some disadvantages. Indeed, currently, it is not easy to deposit a metal layer onto the bottom of a ceramics container, because of the difficulty in establishing a permanent bond. This difficulty is mainly due to problems in particular of dilation, oxidation, fixation and weight of this metal layer. The oxidation of the metal layers, during the process of bonding to the container (in an oven working at more than 800 degrees Celsius) decreases in a considerable way the effectiveness of such a container.

The document EP 0 695 282 proposes to use a metal layer containing silver powder, while having in mind that silver is known for its resistance to oxidation under heat. However, it is not easy to use silver as a basis material for the metal layer in order to generate heat by exposition to an electromagnetic field. Indeed, silver as well as copper are known as being “diamagnetic”. Although any electricity conducting body can be theoretically overheated by induction, it is very well known that a satisfactory efficiency can be obtained only with metals having a high magnetic susceptibility. Under “efficiency” it is understood a relation between the power output by the induction plate and the heating power obtained. Ferromagnetic metals, such as iron, nickel, cobalt or ferritic steel have in particular a satisfactorily high magnetic susceptibility for obtaining a satisfactory efficiency.

The document EP 0 695 282 does not describe the efficiency obtained with a metal layer containing silver powder. However, the following publications are known which deal with the magnetic properties of silver:

“PHYSICAL REVIEW LETTERS, volume 80, number 21 of R. König et al. on Magnetization of Ag Sinters Made of Compressed Particles of Submicron Grain Size and their Coupling to Liquid ³He”, and

“JOURNAL OF LOW TEMPERATURE PHYSICS of Li R. König et al. on Magnetic Properties of Ag sinters and their Possible Impact on the Coupling to Liquid ³He at very low temperature.”

These two documents show that silver in the form of “sintered” fine powder can get unexpected magnetic properties, close to those of ferromagnetic metals, when it is subjected to an intense magnetic field, substantially higher than 1 Tesla.

Using a layer containing metal silver can thus make it possible to obtain an induction heating. However, in the absence of comprehension of the physical phenomena governing induction heating, and in the absence of design control for the induced part, it appeared that the heating power obtained with such a layer is low. Indeed, it is difficult to generate, from silver powder, via the current cooking plates, the magnetic field necessary to cook on a high heat, which can be obtained from substantially 3 Watts/cm².

Moreover, it is known in the state of the art that the inductors used in induction plates generate a magnetic flux, such as induced currents, which are dominating on a part of the metal layer and not very important elsewhere. A non-homogeneous heat flux can cause a thermal shock between hot spots and cold spots in a ceramics container, which can break it. Indeed, ceramic materials are rather sensitive to thermal shocks and mechanical stresses because of their low elasticity.

Today, in spite of the demand, there does not exist on the market ceramics containers able to support a strong heating power output by an induction plate in order to be used as cooking utensils in the same way as metal utensils.

Thus, currently, there is a real need for providing a container made out of ceramics which is adapted to pre-heating as well as to cooking on induction plates.

### OBJECT AND SUMMARY OF THE INVENTION

The purpose of the invention is precisely to meet this need while finding a remedy for the disadvantages of the previously-disclosed techniques. To this end, the invention proposes a cooking utensil usable on an induction plate, having a very good thermal conductivity for an optimal use and being relatively simple to manufacture.

For this purpose, the invention proposes a cooking utensil comprising a ceramics container and a bottom obtained from a paste containing silver powder. Said bottom is deposited outside the container base. When carrying out the invention, it appeared that a design and dimensioning control for this bottom make it possible to obtain, with the current cooking plates, a heating power adapted to cook on a high heat.

Thus, in the invention, the geometry of the deposit is determined so as to optimize the magnetic properties of the silver deposit by distributing in a homogeneous way the heating power output by the induction plate. The thickness of the deposit is defined according to the desired heating power. Moreover, to avoid possible thermal shocks, the dilation coefficient of the container is very low.

Thus, the utensil according to the invention presents a bottom out of silver powder allowing a use with induction systems and a good heat conduction.

Moreover, the variation of the width of the deposit on all the external base of the container makes it possible to quickly propagate heat throughout the container.

The invention thus refers to a cooking utensil comprising a ceramics container, said utensil comprising on an external base of the container a coating layer containing silver powder,

characterized in that

the layer is deposited according to a geometrical form configured so as to optimize the magnetic properties of the silver powder by distributing in a homogeneous way on the container a heating power output by the induction plate,

a thickness of the layer is defined according to the maximum heating power to be reached by the container base.

According to a first preferential embodiment of the invention, the geometrical form includes a succession of protuberances of the layer containing silver powder. A local width of said protuberances of the layer is defined according to the local magnetic field. In this manner, it is possible to modulate the heating power locally.

More preferentially, the geometrical form moreover includes a succession of air channels. Said air channels are delimited by two consecutive protuberances. More preferentially, a bottom of said channels is formed by the external base of the ceramics container. The alternation of protuberances and air channels is configured so that the current induced by the induction plate circulates within the protuberances comprising the silver powder.

Still more preferentially, the protuberances and the air channels have the shape of concentric rings or spirals around a center of the coating layer, said rings or said spirals being circular or elliptic.

According to an alternative, the coating layer comprises a succession of projecting localized protuberances separated by the air channels.

According to a second preferential embodiment of the invention, the external base of the container comprises on its periphery a capillary barrier, said barrier comprising at least two projections raised relative to the coating layer, said at least two projections delimiting at least one groove.

Such projections form a support leg which makes it possible to prevent possible thermal shocks on the bottom of the container, due to an overflow or a flowing of a liquid. This liquid, in particular water, is captured into the leg by capillarity and does not run out towards the coating layer being heated.

Moreover, this leg makes it possible to slightly elevate the utensil from the plate. This elevation of the utensil, for example of a few millimeters, makes it possible to prevent the induction plate from being marked. Indeed, ceramics is rather not very heat conducting and the induction plate generates a very intense heat flow locally. This temperature can exceed 900° C. in certain zones. Such a temperature can cause a softening start for the protective vitreous layer of the induction plate, which can be deformed when it is directly in contact with the cooking utensil.

Preferentially, the shape of the projections and the groove is adapted to the shape of the periphery of the base of the ceramics container. More preferentially, the projections and the groove have a concentric shape. Still more preferentially, this shape is circular or elliptic, according to the shape of the container base.

Preferentially, the barrier comprises three projections delimiting two grooves. The embodiment implementing protuberances of the coating layer can advantageously be combined with the embodiment implementing the capillary barrier. These two embodiments can also be carried out independently.

Advantageously, the thickness of the coating layer is higher than or equal to approximately 10 μm.

Advantageously, the thermal dilation coefficient of said container is ultra-low in particular about 2.10⁻⁶ K⁻¹ at a temperature from 20 to 200° C.

Advantageously, the maximum heating power on the container base for a cooking on a high heat is higher than approximately 3 Watts/cm².

Advantageously, the thickness of the protuberances is higher than or equal to approximately 10 μm.

Advantageously, the utensil is able to be used for a cooking on an induction plate.

Advantageously, said utensil is also able to be used for a cooking with cooking means other than induction, for example microwave ovens, flame or convection.

The object of the invention is also a method for manufacturing a utensil such as described previously. In said method, the deposit of the coating layer onto the ceramics container base is carried out by transfer.

### BRIEF DESCRIPTION OF THE DRAWINGS

The invention will be better understood when reading the following description and examining the annexed figures. Those are given as an indication and by no means a restriction of the invention.

FIG. 1 represents an axial section view of a cooking utensil out of ceramics according to an embodiment of the invention.

FIG. 2 shows an axial section view of the cooking utensil represented in FIG. 1, more precisely illustrating the external base of this utensil.

FIGS. 3 and 4 show a bottom view of a cooking utensil according to two embodiments of the invention.

FIG. 5 is a diagram showing the relation between the radius of a deposit on the external base of the utensil and the heating power of three induction plates having different diameters.

FIGS. 6, 7 and 8 show another embodiment of the invention, in which the external base of the utensil comprises a capillary barrier.

In the following description, the elements with the same function have identical references throughout the Figures.

### DETAILED DESCRIPTION OF THE EMBODIMENTS

In the description under cooking it is understood the possibility of cooking on a high heat. This cooking on a high heat can be obtained by means of a minimal average heat flux of about three Watts/cm² on the base of the container put on the cooking plate.

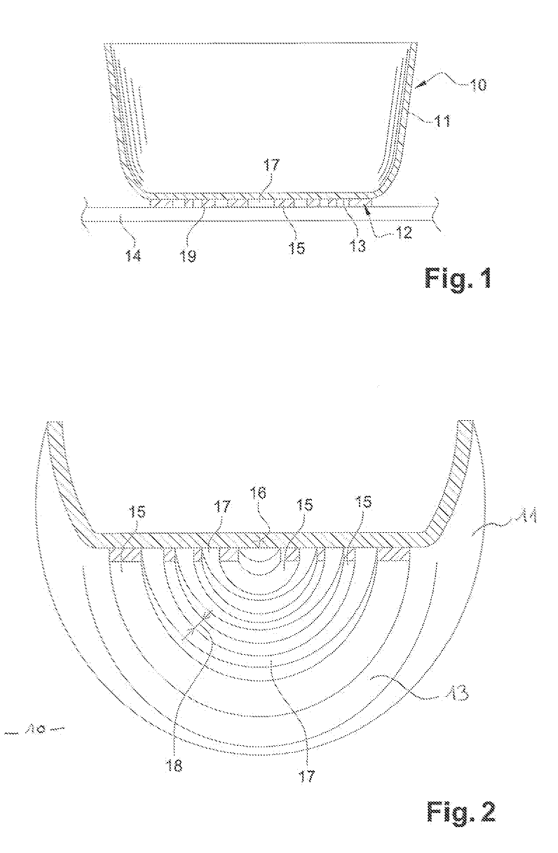

FIG. 1 shows a cooking utensil 10 heated by an induction plate 14. The utensil 10 comprises a container 11 out of ceramics. The container 11 out of ceramics can be out of porcelain, earthenware, terra cotta, vitroceramics, sandstone etc. . . .

The container 11 can be a hollow utensil intended to contain, preserve or transport any substance (liquid, gas or solid). It can also be a dinner plate. This container 11 can take various forms and dimensions.

The container 11 is made according to the traditional process for manufacturing objects out of ceramics. In order to be efficiently used as a cooking utensil, the container 11 must have a good resistance to thermal shocks. For this purpose, the container 11 preferentially has a ultra-low thermal dilation coefficient. In a preferred embodiment, the dilation coefficient of the container 11 is about 2.10⁻⁶ K⁻¹ at a temperature from 20 to 200° C.

The utensil 10 comprises a coating layer 12 on an external base 13 of the container 11. The base 13 has preferentially a plane shape. For example, the layer 12 consists of silver powder and a binder comprising a glass powder. The quantity of silver powder is largely higher than that of the binder. In a preferred embodiment, the layer consists of approximately more than 90% of silver powder and approximately less than 10% of binder. The glass powder is a binding agent making it possible to fix the silver powder.

These materials are mixed in order to obtain a paste in which they are dispersed in a proportional way. This paste is then deposited onto the container 11 according to the traditional techniques in the field of ceramics. This layer 12 is deposited onto the container 11, preferably by transfer. In an alternative, the layer 12 can be applied by serigraphy. The container 11 with the layer 12 is then fired at a temperature, for example approximately from 850 to 900 degrees Celsius. Then, the layer 12 is advantageously covered with a uniform protecting layer. This protecting layer is primarily made up of a glass frit, colored or not.

In a preferred embodiment, the layer 12 substantially has a disc-shaped contour. It can also have a contour with any other geometrical form making it possible to carry out the invention.

As it can be seen in FIG. 1, the layer 12 is deposited in the form of a decoration according to a geometry intended to optimize the magnetic properties of said layer. The layer 12 comprises a succession of protuberances 15 on a face 19 in contact with the induction plate 14. The protuberances 15 are represented in a section view.

The induction heating power is proportional to the surface occupied by the layer 12 in which the current is induced. A reduction of the heating power is obtained by leaving empty spaces in the layer 12. To this end, the protuberances 15 are separated by channels 17, in which the air can circulate. The shape of the air channels 17 and the protuberances 15 define a ribbed profile for the face of the layer 12 in contact with the plate 14.

The presence of these empty spaces 17 moreover allows to control, during the transfer, the thickness of the layer 12. Indeed, the heating power is proportional to the thickness of the layer 12, until the limit penetration depth of the magnetic field. In an embodiment of the invention, the penetration depth is of approximately 20 μm.

The air channels 17 form cavities, each of them comprising a bottom formed by the ceramics base 13 of the container 11. Said air channels 17 are delimited by two successive protuberances. The protuberances 15 form projecting parts of the layer 12.

The geometry of the layer 12 is preferentially configured so that the induced current circulates, within the protuberances 15 comprising silver powder, according to a substantially tangential direction, in cylindrical reference whose axis is perpendicular to the base 13 of the container 11.

In addition, for a good distribution of the heating power, it is preferable that the layer 12 has a substantially rotational symmetrical form around a center 16 of the base 13, in particular if this base has a circular or elliptic contour. FIG. 2 shows a perspective view of the axial section view of the cooking utensil represented in FIG. 1. In FIG. 2, it is shown that the container 11 has a base 13 with a substantially circular contour. The protuberances 15 are formed by an emboss, continuous or not, which is rolled up in a first spiral around a center 16 of the base 13. Thus, the channels 17 have the form of a second spiral fitted between the turns of the first spiral. In an alternative, the base 13 and the spirals can rather have an elliptic profile than a circular one.

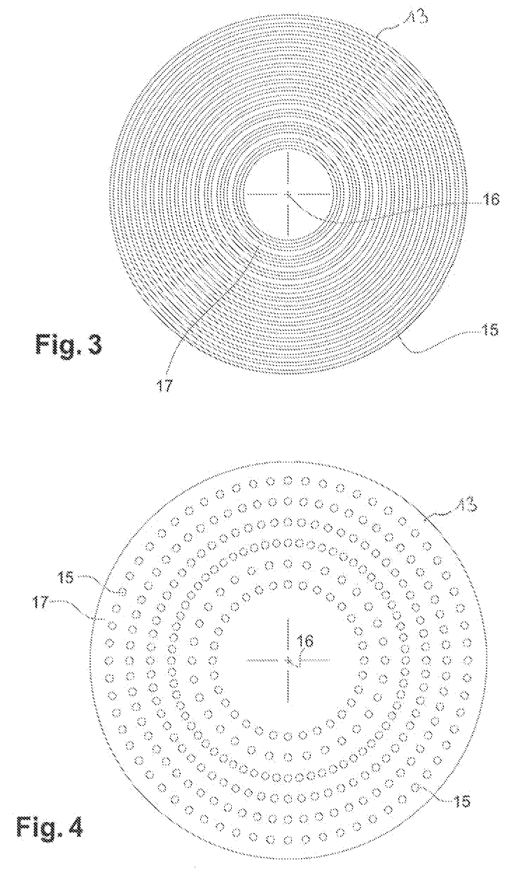

FIG. 3 represents a bottom view of a utensil 10 according to an alternative of the invention. The face of the layer 12 in contact with the induction plate 14 can made up of protuberances 15 and air channels 17 in the form of concentric rings, around the center 16 of the layer 12. The protuberances 15 and the air channels 17 have a circular form. An elliptic form can also be carried out.

In another alternative, as represented in FIG. 4, the contact face of the layer 12 comprises a succession of projecting localized protuberances 15, separated by air channels 17.

In another alternative, the layer 12 has the form of a disc including localized empty spaces.

The protuberances 15 and the air channels 17 can have all the geometrical forms which make it possible to optimize the magnetic properties of silver powder.

The air channels 17 also make it possible to control the thickness of the protuberances 15. The air channels 17 have a depth corresponding to a thickness of the protuberances 15.

A distance such as 18 (see FIG. 2) separating two successive protuberances 15 can be variable according to the concerned zone of the layer 12. In an alternative, a distance 18 between two consecutive protuberances 15 is constant on the layer 12. In this case, the width of the air channels 17 is also constant.

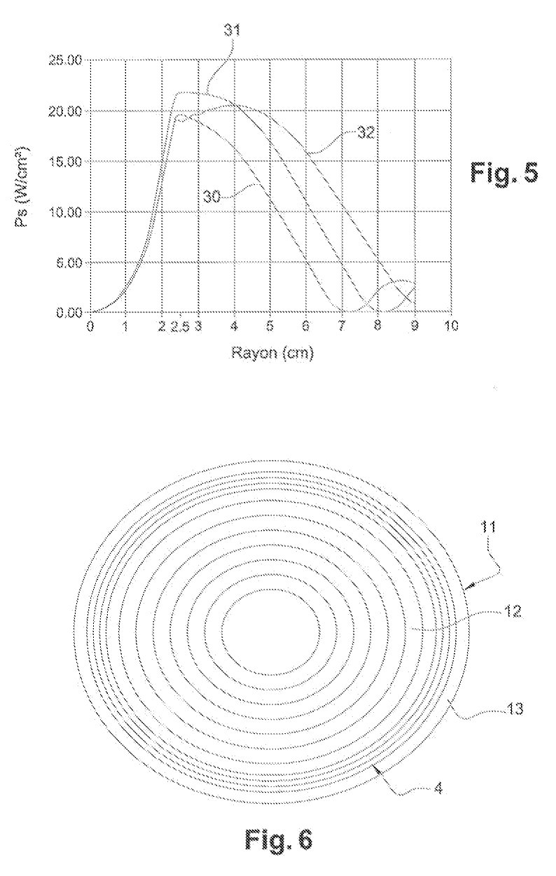

The alternation of the protuberances 15 and the air channels 17 makes it possible to form a heating power divider between the coldest spots, corresponding to the center and the ends of the layer 12, and the hottest spots of the layer 12. This power divider makes it possible to vary the temperature received by the protuberances 15 so as to reduce heat gradients generated by induction. This function will be explained further below when describing FIG. 5.

The thickness of the protuberances 15 is adjusted so as to obtain a sufficient heating power. This thickness is determined so that it is substantially higher than the penetration depth of the magnetic field generated by the induction plate.

At the end of several tests with various theoretical nominal power of the induction plate provided by the manufacturer, there appeared that a thickness of saturation is reached with approximately 20 μm. From this thickness of saturation, the maximum heating power received by the container remains quasi constant.

The table 1 below shows an example of a result obtained with these tests. This table shows a maximum heating power to be reached by the container according to the thickness of the silver layer. This maximum power is substantially equal to a percentage of the theoretical nominal power of the induction plate. This percentage depends in particular on the type of material of the container.

TABLE 1

| | Thickness of the silver layer | | |
|---|---|---|---|
| | (in μm) | | |
| | 10 | 20 | 30 |
| Heating power (in %) | 70 | 90 | 90 |

The table 1 is obtained at the end of several tests, for a theoretical nominal power of the induction plate of approximately 2800 Watts. For a thickness of the layer 12 lower than approximately 20 μm, the heating power obtained thanks to the protuberances 15 is about 70% of the theoretical nominal power. It is only when the thickness of the protuberances 15 is higher than or equal to substantially 20 μm, that it is observed an optimal heating power of the layer 12 of about 90% of the theoretical nominal power of the induction plate.

FIG. 5 is a diagram showing the relation between the surface heating power in Watt/cm² of three induction plates with different diameters and the radius of the layer 12 in centimeters. The x-axis corresponds to the radius of the layer 12 and the y-axis to the heating power output by the induction plate.

FIG. 5 shows three curves 30, 31 and 32 which are graphical representation of the evolution of the power output by an induction plate according to the radius of the layer 12. These three curves were obtained from the local law of Ohm \vec{j}=σ\vec{E}, a being the electric conductivity of silver. The electric field E is calculated by solving the equation of Maxwell-Faraday

$$\vec{rot} \vec{E} = - \frac{\partial \vec{B}}{\partial t}$$

This equation gives the curl of the electric field according to the derivative of the magnetic field with respect to time. The magnetic field B is obtained by summing the turns in the induction plate, whose the respective contributions are given by the law of Biot and Savart.

The curve 30 represents this evolution for an induction plate having a diameter of 16 centimeters and a theoretical nominal power of about 2000 Watts. The curve 31 represents this evolution for an induction plate having a diameter of 18 centimeters and a theoretical nominal power of about 2800 Watts. The curve 32 represents this evolution for an induction plate having a diameter of 21 centimeters and a theoretical nominal power of about 3100 Watts.

FIG. 5 shows that the power output by the three plates around the center 16 of the layer 12 is virtually null. As the center of the plate does not heat, it is thus not necessary to deposit the protuberances 15 near the center 16. The more one moves away from the center 16, the more the power increases.

According to the curve 30, the heating power output presents a stage where it is maximum on the layer 12. This stage is located at a radius of about 2.4-2.6 centimeters. More one moves away from this stage, more the power output decreases until being null at a radius of the layer 12 of approximately 7 centimeters.

According to the curve 31, the heating power output presents a stage where it is maximum on the layer 12. This stage is located at a rayon of about 2.5-3 centimeters. The more one moves away from this stage, the more the power output decreases, until being null at a radius of the layer 12 of approximately 8 centimeters.

According to the curve 32, the heating power output presents a stage where it is maximum on the layer 12. This stage is located at a radius of about 2.5-4 centimeters. The more one moves away from this stage, the more the power output decreases until being null at a radius of the layer 12 of approximately 9 centimeters.

From these three curves 30, 31 and 32, it is possible to determine in a relatively precise way the heating power output at each point of co-ordinates (X, y) of the plane of the layer 12. According to the invention, it is possible to modulate locally the heating power received by the container while exploiting the thickness or the width of the protuberances 15 at each point of the layer 12.

Thus, in the example illustrated in FIG. 3, the thickness of the protuberances 15 is more important when these protuberances are deposited around the center 16. This thickness is then decreased as one approaches the stage and then increased when one moves away from this stage.

In the invention, the number and the dimension of the protuberances 15 on the layer 12 are given according to the reduction of the desired heating power. For example, if one wishes to reduce by 25% the heating power received by the layer 12, the covering ratio covering of the protuberances containing silver powder on the layer 12 must be approximately of 75%.

In an embodiment, the protuberances 15 have a width from 1 to 10 millimeters and the distance 18 of the air channels is higher than or equal to approximately 0.5 millimeters.

The alternation of the air channels 17 and the protuberances 15 having different widths makes it possible to reduce the variations in temperature received by the container by modulating the heating power locally.

The particular form, the distribution and the thickness of the protuberances 15 can give place to many variations, primarily guided by the optimization of the magnetic properties of the layer 12 and by the homogeneity of the heat flux on the container.

In the example in FIG. 3, there are respectively twelve protuberances 15 and air channels 17. The layer 12 deposited onto the base 13 has an external diameter of about 152 millimeters. A central empty space 20 located at the center of the layer 12 has a diameter of about twenty millimeters.

In short, the invention provides a layer containing silver powder with a given thickness so as to be able to obtain a heating power sufficient for an optimal use in cooking The silver layer is moreover deposited according to a geometrical form configured both for controlling the thickness deposited and for limiting the heat gradients on the utensil. This limitation of the gradients makes it possible to preserve the integrity of the utensil and to limit the risks of burning food.

In an embodiment, the layer 12 can have a diameter higher than approximately twelve centimeters, being able to reach a maximum heating power of about 5 to 7 Watts/cm². For a layer 12 with a diameter lower than or equal to approximately 12 centimeters, the maximum power can reach 10 Watts/cm².

FIGS. 6, 7 and 8 show another embodiment of the invention. According to this embodiment, the external base 13 of the container 11 comprises a capillary barrier 40, in addition to the layer 12. This capillary barrier 40 makes a improvement to the embodiments in which the external base 13 of the container 11 has a plane shape. Indeed, in certain circumstances, this plane shape can have some disadvantages.

These disadvantages are in particular related to the very high temperature which certain zones of the container 11 can reach. Indeed, ceramics is a material relatively not very heat conducting compared to metals, with a conductivity of about 2 W.m⁻¹.K⁻¹, against for example 30 W.m⁻¹.K⁻¹ for steel. The speed of heat transfer towards the contents of the container 11 is thus reduced. The bottom of said container 11, when it is heated by induction, can present zones of very high temperature, near to 900° C.

A flowing of liquid can occur on the wall of the container 11, such as condensed water under the lid or due to an overflow of a liquid contained in said container. The liquid can then penetrate by capillarity up to the interstice between the flat bottom of the utensil 10 and the cooking plate 14. A severe thermal shock can occur between the liquid, whose maximum temperature is of approximately 100° C., and certain zones of the utensil 10, whose temperature can approach 900° C. As ceramics is by nature a so-called “fragile” material, i.e. it is not ductile and not very deformable, this shock can possibly damage the container 11 in the form of a dynamic fracture. The fracture can also be caused by a fatigue damage, due to a repetition of thermal shocks which have occurred during the various uses of the container.

In certain cases, the temperature reached locally on the external base 13 of the container 11, during its heating on the induction plate 14, can reach the temperature of softening of the fusible mineral materials of the layer 12. Indeed, the layer 12 containing silver comprises vitrifiable mineral materials, fusible at approximately 900° C., in order to ensure the firing fixation and the protection of the silver particles. So, if there is a contact between the layer 12 and the induction plate 14, the layer is then likely to mark said plate.

In the same way, in the event of a direct contact between the glass panel of the cooking plate 14 and the bottom of the ceramics container 11, which includes very hot zones, close to 900° C., the heat transfer towards said cooking plate 14 is not insignificant. A local degradation of the internal structures of the cooking plate, in the very hot zones, can thus occur after a certain period of time.

In addition, cooling ceramics is a relatively slow process. During a fast passage of the container 11 from the induction plate 14, where it is in the process of heating up, towards a support such as a working surface or a serving table, there is a risk of burning the support, even a risk of thermal shock potentially detrimental to the container 11, in particular if the support is wet.

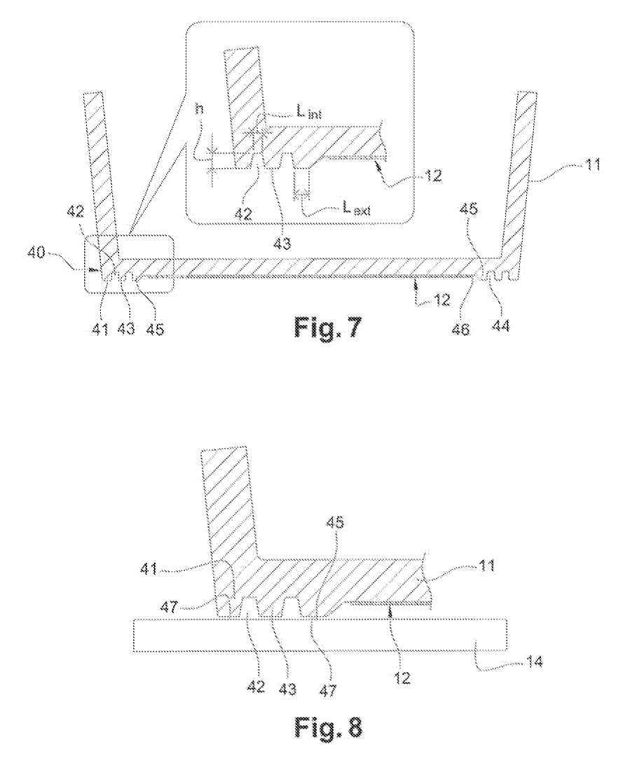

A capillary barrier 40 can be made to find a remedy for these various disadvantages. FIG. 6 shows an example of a schematic representation of the external base 13 provided with such a barrier 40. This barrier is represented in more detail in FIGS. 7 and 8.

Classically, this barrier 40 is made by shaping the mould, whatever the working technique for the ceramic paste, in particular a casting or pressing technique.

The barrier 40 according to the invention comprises an external emboss-shaped projection 41 located near the external wall of the container 11, delimited by a hollow formed by a first groove 42. The barrier 40 also comprises a intermediate emboss-shaped projection 43 delimited by the first groove 42 and by another hollow formed by a second groove 44. This barrier finally comprises an intern emboss-shaped projection 45 delimited by the second groove 44 and a bottom wall 46 of the container 11 intended to receive the layer 12.

In the example represented in FIGS. 6 to 8, the external base comprises only one barrier 40 whose three projections 41, 43 and 45 and two grooves 42 and 44 are annular and concentric. The barrier 40 represented is carried out on the whole external circumference of the base 13 of the container 11, near the periphery. In this example, the barrier 40 is carried out with at approximately three millimeters from the periphery, so as to maximize the surface of the layer 12 and to ensure a better stability of the container 11 on the induction hob.

The three projections 41, 43 and 45 extends over a certain height above the layer 12 so that the container 11 is supported by the plate 14 only via said projections. Said projections (41, 43, 45) form a support leg. In an embodiment example, the height of the projections is approximately of 0.5 mm above the layer 12.

In the example illustrated in FIGS. 6 to 8, the presence of two grooves 42 and 44 makes it possible to constitute, on the top of the projections, three capillary pumping zones corresponding to the so-called horizontal capillary traps.

Indeed, some zones 47 between the induction plate 14 and the top of the projections form the horizontal capillary traps. The flowing liquid falling to the bottom of the container 11 on the cooking plate 14 is pumped by capillarity between said plate and said top of the projections, possibly through the hollow zones formed by the grooves 42 and 44. The barrier 40 thus makes it possible to capture the liquid by capillarity and forms a tight barrier opposed to any penetration of said liquid towards the layer 12.

Moreover, the projections 41, 43 and 45 are made out of ceramics. When heating on the induction plate 14, they remain at a moderate temperature, lower than 100° C. These projections are able to retain the flowing liquids without any thermal shock able to damage the container 11. Ceramics is indeed able to resist to thermal shocks such as when a test-tube, previously heated at 300° C., is dipped in water at 20° C.

The grooves 42 and 43 form so-called vertical capillary traps. Their role is to keep liquids between the pumping zones. Their presence is useful in particular when raising the container 11 from the cooking plate 14. If they were not present, the water in the horizontal capillary traps could be aspired when raising the container then flow towards the layer 12, the horizontal capillary protection being removed only by raising the utensil. The grooves 42 and 44 thus form permanent capillary traps, replacing the horizontal capillary traps formed by the interface between the flat tops of the projections 41, 43 and 45 and the cooking plate 14, those being present only when the container 11 is put on the cooking plate 14.

In an embodiment example, the grooves 42 and 44 have a height H of approximately 2 mm. The dimensions of these grooves 42 and 44 are determined so that the hollow space in said grooves cannot be stopped, at the time of the enameling operation during the manufacture of the utensil 10. The internal width Lint of the grooves 42 and 44 is for example of about 1.5 mm. The external width Next of the grooves 42 and 44 is for example of about 2 mm. In the description, the terms “internal” and “external” are understood in reference to the direction of contact of the container 11 on the induction plate 14 and to the position of the contents of the container 11.

In a preferred embodiment, the internal width Lint of the grooves 42 and 44 is lower than the external width Next of said grooves. These dimensions of the grooves 42 and 44 makes it possible to remove more easily the container 11 from the mould, after working the paste.

In the embodiment illustrated in FIGS. 6 to 8, the grooves 42 and 44 have a trapezoidal section of approximately 3.5 mm². In other embodiments, the grooves can have a rectangular or hemispherical section.

In a general way, the dimensions of the barrier 40 is determined so as to make it possible to ensure a perfect stability of the container 11 without spoiling the esthetics thereof while forming a capillary barrier for which the water retention capacity of the grooves is rather efficient.

The present invention is not limited to the embodiments described above. Many embodiment alternatives are possible without getting out of the context defined in the annexed claims.

In particular, the number of projections and grooves of a barrier can be different from that of the embodiment illustrated in FIGS. 6 to 8. For example, the barrier 40 can comprise only one groove 42 framed by two projections (41, 43). In an alternative, the barrier 40 can comprise more than two grooves. However, the width of the barrier 40 would then be increased, which could reduce excessively and unnecessarily the surface of the bottom wall of the container receiving the layer 12.

Moreover, the layer 12 can have any geometrical form and any thickness able to provide the container with a heating power adapted to cooking Advantageously, the layer 12 comprises protuberances 15 and air channels 17, as represented in FIGS. 1 to 4.

The cooking utensil obtained according to the invention can also be adapted to any conventional means of cooking other than induction cooking These conventional means can be selected among microwave ovens, gas burner, radiant burner, furnace, barbecue etc . . . .

1. Cooking utensil (10) comprising a container (11) made out of ceramics, said utensil comprising on an external base (13) of the container a coating layer (12) containing silver powder,
characterized in that
the layer is deposited according to a geometrical form configured so as to optimize the magnetic properties of the silver powder by distributing in a homogeneous way on the container a heating power output by the induction plate,
a thickness (18) of the layer is defined according to the maximum heating power to be reached by the base of the container.

2. Utensil according to claim 1, wherein the geometrical form includes a succession of protuberances (15) of the layer containing silver powder.

3. Utensil according to claim 2, wherein the geometrical form moreover includes air channels (17), said air channels being delimited by two consecutive protuberances and comprising a bottom formed by the external base of the ceramics container (11).

4. Utensil according to claim 3, wherein the protuberances and the air channels have the shape of concentric rings or spirals around a center (16) of the layer, said rings or said spirals being circular or elliptic.

5. Utensil according to claim 3, wherein the coating layer (12) comprises a succession of localized projecting protuberances separated by the air channels.

6. Utensil according to any one of the preceding claims, wherein:
the external base comprises on its periphery a capillary barrier (40),
said barrier comprising at least two emboss-shaped projections (41, 43, 45) relative to the coating layer (12), said at least two projections delimiting at least one groove (42, 44).

7. Utensil according to claim 6, wherein the projections and the groove have a concentric form.

8. Utensil according to claim 6 or claim 7, wherein the barrier comprises three projections delimiting two grooves.

9. Utensil according to any one of the claims 7 to 8, wherein the projections and the grooves have a circular or elliptic form.

10. Utensil according to any one of the preceding claims, characterized in that the thickness of the coating layer (12) is higher than or equal to approximately 10 μm.

11. Utensil according to any one of the preceding claims, characterized in that the thermal dilation coefficient of the container (11) is about 2.10⁻⁶ K⁻¹ at a temperature between 20 and 200° C.

12. Utensil according to any one of the preceding claims, characterized in that the maximum heating power on the base of the container for a cooking on a high heat is higher than approximately 3 Watts/cm².

13. Utensil according to any one of the preceding claims, wherein it is able to used for a cooking on an induction plate (14).

14. Utensil according to claim 13, wherein it is able to be used for a cooking with cooking means selected among microwave ovens, flame or convection.

15. Method for manufacturing a utensil according to any one of the preceding claims, characterized in that the deposit of the layer (12) on the base of the container (11) is carried out by transfer.

16. A cooking utensil, comprising a ceramics container; an external base of the ceramics container; and a coating layer containing silver powder on the external base, the coating layer being deposited according to a geometrical form configured to optimize magnetic properties of the silver powder by distributing in a homogeneous manner on the ceramics container a heating power output by an induction plate; and wherein a thickness of the coating layer is defined according to the maximum heating power to be reached by the base of the container.

17. The utensil of claim 16, wherein the geometrical form comprises a succession of protuberances of the coating layer containing silver powder.

18. The utensil of claim 17, wherein the geometrical form further comprises air channels, the air channels being delimited by two consecutive protuberances and comprising a bottom formed by the external base of the ceramics container.

19. The utensil of claim 18, wherein the protuberances and the air channels have a shape of concentric rings or spirals around a center of the coating layer, the rings or the spirals being circular or elliptic.

20. The utensil of claim 18, wherein the coating layer comprises a succession of localized projecting protuberances separated by the air channels.

21. The utensil of claim 16, wherein the external base comprises on its periphery a capillary barrier; wherein the capillary barrier comprises at least two emboss-shaped projections relative to the coating layer; and wherein said at least two projections delimit at least one groove.

22. The utensil of claim 21, wherein the projections and the groove have a concentric form.

23. The utensil of claim 21, wherein the capillary barrier comprises three projections delimiting two grooves.

24. The utensil of claim 22, wherein the projections and the grooves have a circular or elliptic form.

25. The utensil of claim 23, wherein the projections and the grooves have a circular or elliptic form.

26. The utensil of claim 16, wherein thickness of the coating layer is equal to or greater than 10 μm.

27. The utensil of claim 16, wherein a thermal dilation coefficient of the ceramics container is substantially 2.10⁻⁶ K⁻¹ at a temperature between 20 and 200° C.

28. The utensil of claim 16, wherein a maximum heating power on the external base of the ceramics container for a cooking is higher than 3 Watts/cm².

29. The utensil of claim 16 for use in cooking on an induction plate.

30. The utensil of claim 29 for use in cooking with one of the following cooking means microwave ovens, flame or convection.

31. A method for manufacturing the utensil of claim 16, comprising the step of depositing the coating layer on the external base of the ceramic container by transfer.
